(19) United States
(12) Patent Application Publication
(10) Pub. No.: US 2005/0227145 A1
(43) Pub. Date: Oct. 13, 2005

(54) Alkaline battery

(75) Inventors: Shinichi Iwamoto, Osaka (JP); Yoshihisa Hirose, Osaka (JP); Noriyuki Ito, Osaka (JP)

Correspondence Address: BIRCH STEWART KOLASCH & BIRCH, PO BOX 747, FALLS CHURCH, VA, 22040-0747, US

(73) Assignee: HITACHI MAXWELL, LTD.

(21) Appl. No.: 11/100,459

(22) Filed: Apr. 7, 2005

(30) Foreign Application Priority Data
Apr. 9, 2004 (JP) P2004-115152
Sep. 8, 2004 (JP) P2004-260542

(51) Int. Cl. H01M 4/58; H01M 4/42; H01M 4/50; H01M 4/52

(52) U.S. Cl. 429/224; 429/231.5; 429/229; 429/27

(57) ABSTRACT

An alkaline battery comprising manganese dioxide as a positive electrode active material, wherein the positive electrode active material has a BET specific surface area of 40 to 100 m²/g and a particle size distribution is such that a volume fraction of particles having a particle size of 20 to 52 μm is at least 50%.

The present application claims priority to Application Nos. 2004-115152 and 2004-260542, filed in Japan on Apr. 9, 2004 and Sep. 8, 2004 respectively, and which are herein incorporated by reference in their entirety.

### BACKGROUND OF THE INVENTION

1. Field of the Invention

The present invention relates to an alkaline battery, in particular, an alkaline battery having an excellent load characteristic.

2. Description of the Related Art

Alkaline batteries which utilize zinc as a negative electrode active material are used as a power source for various electronics, and have required characteristics which vary depending on their usage. Particularly, in the case of a digital camera whose use has spread rapidly in recent years, in order to increase the capacity to shoot pictures as much as possible, the batteries are required to provide a higher capacity and a more improved load characteristic such as a large current discharge characteristic. Therefore, battery designs which can fulfill these demands are desired.

To achieve a higher capacity, it is necessary to increase the filling amount of an active material. However, increasing the filling amount of an active material alone cannot increase the capacity, because unless the active material is effectively utilized for discharging, the increased amount of the active material does not lead to an increase in the capacity. The discharge capacity depends on the efficiency that the active material is utilized, thus it is necessary to design a positive electrode, a negative electrode and an electrolytic solution to give a discharge reaction which proceeds smoothly. The discharge reaction in a positive electrode of an alkaline battery comprising, manganese dioxide as a positive electrode active material, proceeds according to the following formula (1).
Positive electrode: MnO₂+H₂O+e⁻→MnOOH+OH (1)

Apparent from the above formula (1), in the positive electrode, water is consumed during the discharge, so it is desirable from the point of the discharge reaction that as much water as possible is reacted rapidly and effectively on the positive electrode side in the battery.

From the above, to improve the discharge reaction of the manganese dioxide used in an alkaline dry battery for equipment requiring a large current, manganese dioxide preferably has a larger reaction surface area, and thus manganese dioxide having a sufficiently large specific surface area is required.

Thus, electrolytic manganese dioxide having high specific surface area such as from 40 m²/g to 60 m²/g is proposed to improve the discharge characteristics (see JP-A-10-228899, at the paragraph numbered as 0028).

However, in manganese dioxide, the specific surface area is usually inversely related to its bulk density, and the electrolytic manganese dioxide having the above-mentioned high specific surface area has a decreased bulk density. Therefore, there arise problems such as the difficulty in handling of the manganese dioxide during production of the bobbin-form molded body of a positive electrode mixture because of poor moldability, and insufficient body strength of the molded form due to cracking in the molded body. In addition, even if molded, there also arise problems of reduced capacity due to poor filling properties. In addition, in the case of using manganese dioxide having such a high specific surface area, there is a problem such that the amount of an electrolytic solution contained in a positive electrode mixture is insufficient, and the capacity decreases if the electrolytic solution cannot be contained sufficiently.

### SUMMARY OF THE INVENTION

The present invention intends to solve the problems described above. According to the present invention, manganese dioxide having a large specific surface area with a specific particle size distribution in a particular range is used and contained in a positive electrode mixture to provide an alkaline battery having an excellent load characteristic and a high discharge capacity, with which a stable molded body can be produced, even when such manganese dioxide having a large specific surface area is used.

According to the first embodiment, the present invention provides an alkaline battery comprising manganese dioxide as a positive electrode active material, wherein the positive electrode active material has a BET specific surface area of 40 to 100 m²/g and a particle size distribution is such that a volume fraction of particles having a particle size of 20 to 52 μm is at least 50%.

According to the second embodiment, the present invention provides an alkaline battery comprising manganese dioxide as a positive electrode active material, wherein the manganese dioxide is a mixture of high specific surface area manganese dioxide having a BET specific surface area of 40 to 100 m²/g and low specific surface area manganese dioxide having a BET specific surface area of less than 40 m²/g.

According to the third embodiment, the present invention provides an alkaline battery comprising manganese dioxide as a positive electrode active material, wherein, after the assembly of the battery, a positive electrode mixture contains an alkaline electrolytic solution comprising potassium hydroxide, and a water content in the positive electrode mixture is from 8.4 to 10% by weight based on the weight of the positive electrode mixture including the electrolytic solution.

According to the present invention, when the alkaline battery comprising manganese dioxide as a positive electrode active material, and the positive electrode active material has a BET specific surface area of 40 to 100 m²/g and a particle size distribution is such that a volume fraction of particles having a particle size of 20 to 52 μm is at least 50%, the moldability of the positive electrode mixture can be improved, and the load characteristic and discharge capacity can be improved even when the active material with a large specific surface area is used.

### BRIEF DESCRIPTION OF THE DRAWINGS

FIG. 1 is a cross sectional view showing a usual structure of a conventional alkaline battery;

FIG. 2 is a cross sectional view showing a total structure of an alkaline battery, which utilizes a negative electrode-terminal plate as a support mean for supporting a sealing member from the inside; and

FIG. 3 is a particle size distribution chart of mixed manganese dioxide used in Example 5.

### DETAILED DESCRIPTION OF THE INVENTION

Hereinafter, the production of an alkaline battery of the present invention will be explained.

In the alkaline battery of the present invention comprising manganese dioxide as a positive electrode active material, the positive electrode active material has a BET specific surface area of 40 to 100 m²/g and a particle size distribution is such that a volume fraction of particles having a particle size of 20 to 52 μm is at least 50%.

When the BET specific surface area is smaller than 40 m²/g, the reaction area is small and thus reaction efficiency is low, and the load characteristic is not improved, while the moldability is improved. When the BET specific surface area exceeds 100 m²/g, the bulk density is low and thus the moldability deteriorates, while the reaction efficiency is high. To strengthen the molded body of the positive electrode and to improve the moldability, the BET specific surface area is more preferably 60 m²/g or less. Preferably, the BET specific surface area is at least 45 m²/g.

The active material has a particle size distribution such that a volume fraction of particles having a particle size of 20 to 52 μm is at least 50%. When a large number of particles having a particle size of less than 20 μm are present, the bulk density decreases, moldability deteriorates and the capacity decreases. When a large number of particles having a particle size of more than 52 μm are present, the filling characteristic deteriorates and the capacity decreases. Preferably, a volume fraction of particles having a particle size of 20 to 52 μm is at least 60%, and more preferably at least 65%.

In the present invention, as described above, an alkaline battery having an improved load characteristic and an improved discharge capacity without a reduction in moldability can be obtained by the use of manganese dioxide having the particular BET specific surface area and the particular particle size distribution as a positive electrode active material.

In one preferred embodiment, the alkaline battery of the present invention comprising manganese dioxide as a positive electrode active material is characterized in that the manganese dioxide is a mixture of high specific surface area manganese dioxide having a BET specific surface area of 40 to 100 m²/g and low specific surface area manganese dioxide having a BET specific surface area of less than 40 m²/g. When such a manganese dioxide mixture is used as an active material, the load characteristic can be improved while maintaining good moldability. Preferably, the mixture contains high specific surface area manganese dioxide having a BET specific surface area of 45 to 70 m²/g and low specific surface area manganese dioxide having a BET specific surface area of less than 40 m²/g.

The weight ratio of the high specific surface area manganese dioxide to low specific surface area manganese dioxide is preferably from 30:70 to 95:5. When the weight ratio of the high specific surface area manganese dioxide exceeds the above range, the moldability deteriorates due to a low bulk density of high specific surface area manganese dioxide, and thus the production of the molded body with an appropriate strength becomes difficult. When the weight ratio of the high specific surface area manganese dioxide is smaller than the above range, the reaction efficiency of manganese dioxide in the whole active material decreases and the load characteristic may not be sufficiently improved. More preferably, the mixing ratio of the high specific surface area manganese dioxide to the low specific surface area manganese dioxide is from 50:50 to 95:5 by weight.

Preferably, the high specific surface area manganese dioxide used in a positive electrode active material contains 0.01% to 3.0% by weight of titanium. When titanium is used, manganese dioxide has a higher specific surface area to increase the reaction efficiency, and thus the alkaline battery having improved load characteristics can be obtained. More preferably, the positive electrode active material contains 0.01% to 1.0% by weight of titanium.

A characteristic of the high specific surface area manganese dioxide used in the positive electrode active material of the present invention is that the weight loss is preferably at least 2.5%, when it is heated from 200° C. to 400° C. at a rate of 5° C./min. With such a large weight loss caused by heating in this temperature range, it is clear that the manganese dioxide contains a large amount of water in its crystal structure, and therefore the reaction in the discharge step will proceed efficiently and the load characteristic will be improved. More preferably, the weight loss is at least 2.7%, when it is heated from 200° C. to 400° C. at a rate of 5° C./min.

Preferably, manganese dioxide having a high specific surface area used in a positive electrode active material has a component percentage of 32% or less of space group Pnma (62), when the manganese oxide is analyzed by the Rietveld method as a mixed crystal of space groups orthorhombic Pnma (62) and hexagonal P63/mmc (194), using trivalent manganese, tetravalent manganese and oxygen, by means of a X-ray diffraction pattern. The component percentage is more preferably 25% or less, and most preferably 15% or less. When the component percentage exceeds 32%, the specific surface area of manganese dioxide is small, and thus the load characteristic is not improved.

For example, the manganese dioxide having a high specific surface area can be produced as follows:

Electrolytic manganese dioxide is usually prepared by roasting and grinding manganese ores, adding sulfuric acid thereto, neutralizing the ground ores, filtering, and purifying them to form an electrolysis solution containing manganese sulfate and a sulfuric acid solution, and then electrolyzing the electrolysis solution. Here, when the electrolysis solution, to which a titanium compound such as titanium sulfate, titanium nitrate and titanium chloride is added, is used, electrolytic manganese dioxide having titanium incorporated therein can be obtained, and such manganese dioxide containing titanium has a high specific surface area.

Furthermore, when an electrolyzing current density in the above electrolysis is set to at least 50 A/m², which is higher than the usual current density, manganese dioxide having a high specific surface area can be obtained.

Alternatively, when an electrolyzing temperature in the above electrolysis is set at 90° C. or higher, which is higher than the usual electrolysis temperature, manganese dioxide having a high specific surface area can also be obtained.

Besides, the addition of an aqueous phosphoric acid solution to the above electrolysis solution, manganese dioxide having a high specific surface area may also be obtained.

The bulk density of a positive electrode active material is preferably at least 1.55 g/cm³. When the bulk density is smaller than 1.55 g/cm³, the moldability deteriorates, sufficient strength of the molded body for the battery production cannot be secured, (for example, the molded body cracks) and even if it can be molded, the capacity is lowered due to the poor filling characteristic.

In the alkaline battery of the present invention, the water content in the positive electrode mixture is preferably from 8.4 to 10% by weight based on the weight of the positive electrode mixture including the electrolytic solution, after the assembly of the battery, because the discharge reaction in the positive electrode of the alkaline battery, which comprises manganese dioxide as a positive electrode active material is a water-consuming reaction, and thus the reactivity is improved by the presence of a high amount of water contained in the positive electrode mixture. Accordingly, in order to allow a high amount of water to be contained in the positive electrode mixture, it is required that a relatively large amount of water can transfer from a separator or a negative electrode into the positive electrode. To make the water move, a driving force is necessary. In one example of a method for generating such a driving force, alkaline concentrations are made greatly different between the electrolytic solution which is beforehand contained in the positive electrode mixture and the electrolytic solution which is charged during assembling or the electrolytic solution contained in the negative electrode in advance. After assembly, the water in the separator and negative electrode is forced to transfer into the positive electrode mixture by the difference in the ion concentrations. More preferably, the water content in the positive electrode mixture is from 8.6 to 9.5% by weight.

The positive electrode is prepared by mixing manganese dioxide, a conductive aid and an alkaline electrolytic solution containing potassium hydroxide, and molding the mixture to form a molded body. When the concentration of potassium hydroxide in the alkaline electrolytic solution prior to mixing is higher than 50% by weight, the above-mentioned driving force becomes larger and it is possible that the positive electrode mixture consisting of manganese dioxide having a high specific surface area takes up too much water. In addition, since the binding force of the mixture is increased and a homogeneous mixture is formed, manganese dioxide having a high specific surface area can be filled at a high density. The density of the positive electrode mixture is preferably from 3.2 to 3.35 g/cm³, since a high amount of water can be added while the preferred filling amount of the active material can be obtained.

Since manganese dioxide having a high specific surface area which is an active material usually contains varying amounts of water due to adsorption etc., the concentration of potassium hydroxide in the alkaline electrolytic solution contained in the mixture is lower than the concentration of potassium hydroxide in the alkaline electrolytic solution when it is first added. Accordingly, when considering the final water content, the water contained in the above-mentioned active material should also be considered. It is desirable to control the final concentration of the alkaline electrolytic solution to be added to a mixture so that the concentration of potassium hydroxide in the electrolytic solution contained in the mixture is at least 40% by weight. Preferably, the concentration of potassium hydroxide in the electrolytic solution contained in the mixture is at least 42% by weight.

Furthermore, the amount of the alkaline electrolytic solution to be added is selected so that the amount of potassium hydroxide is preferably in a range from 2.4 to 4% by weight, and the amount of water is preferably in a range from 3.0 to 4.2% by weight, both based on the total weight of the mixture including the electrolytic solution contained in the mixture. Thereby, an appropriate driving force can be generated, and the water content after the assembly of the battery can be easily controlled. More preferably, the amount of the alkaline electrolytic solution to be added is selected so that the amount of potassium hydroxide is in a range from 2.9 to 3.5% by weight.

In preparing the above-mentioned positive electrode mixture, when the concentration of potassium hydroxide in an electrolytic solution is higher than 50% by weight, the concentration exceeds the saturation point of potassium hydroxide at room temperature, and thus the mixture may become less homogeneous due to the precipitation of potassium hydroxide. Therefore, it is desirable to increase the saturated concentration of potassium hydroxide by mixing the components of the mixture under a heated atmosphere to prepare the positive electrode mixture under the condition where the electrolytic solution does not reach to the saturated concentration. The preparation of the positive electrode mixture is carried out preferably at a temperature of at least 35° C. In order to prevent the change of the composition of the electrolytic solution by evaporation of water, 70° C. or lower is desirable.

In addition to the above described components, any conventional additives such as a conductive agent and a binder may be contained in the positive electrode mixture. As the conductive agent; carbon materials such as graphite, acetylene black, carbon black, fibrous carbon and mixtures thereof are preferred. Among them, graphite is most preferably used. The amount of the conductive agent to be added is preferably at least 3 parts by weight per 100 parts by weight of the positive electrode active material. When a sufficient of water is contained in the positive electrode mixture and the conductivity of the positive electrode is improved, the reactivity of the active material increases, and further improvement of the load characteristic is expected. On the other hand, the decrease of the filling amount of the active material is not desirable, and thus the amount of the conductive agent is preferably 8.5 parts by weight or less. More preferably, the amount of the conductive agent is 5 to 8.5 parts by weight.

As a binder, at least one of carboxymethylcellulose, methylcellulose, polyacrylate, polytetrafluoroethylene, polyethylene and the like may be used.

According to the present invention, the increase of the reactivity of the positive electrode may achieve further effects described below:

When abnormal conditions such as the short circuit of a battery occur by accident, an excessive short circuit current keeps flowing to cause heating, which quickly increases the temperature of a battery, and the battery suffers from various problems such as a liquid leak and the burst of the battery. In contrast, the discharge reaction in the positive electrode of the battery according to the present invention proceeds more quickly than conventional batteries, and owing to this, the discharge reaction in the negative electrode also proceeds quickly. Accordingly, after the formation of the short circuit, a large amount of discharge products are immediately deposited on the surface of the negative electrode to prevent the discharge reaction. As a result, the short circuit current is significantly decreased in a short time, and the temperature rise of the battery is controlled. Consequently, the above-mentioned problems can be prevented.

Next, the structure of the negative electrode is explained.

Usually, the negative electrode is prepared in the form of a gel-type mixture by mixing zinc or a zinc alloy powder as an active material, a gelling agent and an alkaline electrolytic solution containing potassium hydroxide dissolved therein. In this case, the concentration of potassium hydroxide in the electrolytic solution of the negative electrode is preferably 38% by weight or less. As the alkaline concentration in the electrolytic solution is lowered, the water content increases, and thus the water content needed in the battery as a whole is easily controlled. Furthermore, the concentration of potassium hydroxide is preferably 35% by weight or less, more preferably 33.5% by weight or less in order to improve the load characteristic and to make it easy to effect the prevention of heat-generation at the time of short circuiting as described above by improving the reactivity of the negative electrode through the increase of the ionic conductivity of the electrolytic solution. On the other hand, as the concentration of potassium hydroxide is higher, the characteristic of the battery is less deteriorated during storage at high temperature. Therefore, the concentration of potassium hydroxide is at least 28% by weight, more preferably at least 30% by weight.

To cope with heavy loads such as a pulse discharge with a large current, it is desirable to increase the reaction area by reducing the particle size of the active material. For example, it is preferable that a percentage of active material powder which passes through sieve openings of 200 mesh is at least 4% by weight. It is preferred that the percentage is at least 15% by weight to significantly improve the load characteristic. To prepare a homogeneous negative electrode mixture having good fluidity, the percentage of the microparticles above is preferably 50% by weight or less. More preferably, the percentage of the microparticles above is preferably 30% to 45% by weight. When the microparticles are contained in the particular percentage, problems such as gas generation through the reaction of the active material with the electrolytic solution and the decreased discharge capacity tend to arise during the storage at high temperature. To prevent these problems, it is preferred that the zinc contains elements such as indium, bismuth and/or aluminum. The contents of indium, bismuth and/or aluminum are preferably 0.03 to 0.07% by weight, 0.007 to 0.025% by weight and 0.001 to 0.004% by weight, respectively. In addition, as the particle size decreases, the problem of heating in the case of short circuiting becomes worse. However, in the present invention, the heat preventing effect is exerted sufficiently even if such microparticles are used.

As components other than those described above, small amounts of at least one of an indium compound such as indium oxide, a bismuth compound such as bismuth oxide and the like may be contained in the negative electrode mixture. When these compounds are added, gas generation through the reaction of the zinc alloy powder with the electrolytic solution can be effectively prevented, while the load characteristic may be decreased. Thus, the concentration of these are determined on a case by case basis.

The alkaline battery of the present invention is produced by installing the above-described positive electrode mixture and the negative electrode mixture with a separator inserted between them in the inside of an outer body. But, the total amount of the electrolytic solution contained in the positive and negative electrode mixtures is insufficient. Thus, usually, the additional amount of the electrolytic solution is charged and absorbed by the separator and also the positive electrode. The alkaline electrolytic solution charged in this step preferably has a concentration of potassium hydroxide of 35% by weight or less in order to increase the water supply to the positive electrode by increasing the water content. Furthermore, on the one hand, in the view of improving the load characteristic and the prevention of heat generation in the case of short circuiting, 33.5% by weight or less of potassium hydroxide is desirable. On the other hand, the higher the concentration of potassium hydroxide, the less deterioration of the battery will occur during storage at high temperatures. Thus, the concentration of potassium hydroxide is preferably at least 28% by weight, more preferably at least 30% by weight.

To decrease the deterioration of the battery during storage at high temperatures, a zinc compound is preferably contained in at least one of the electrolytic solution used in preparation of the positive electrode mixture, the electrolytic solution used in preparation of the negative electrode mixture, and the electrolytic solution that is additionally charged. As a zinc compound, at least on soluble compound such as zinc oxide, zinc silicate, zinc titanate and zinc molybdate may be used, and particularly, zinc oxide is preferably used.

After the assembly of the battery, water is transferred from the electrolytic solution that is additionally charged or the electrolytic solution in the negative electrode mixture to the positive electrode, and the water is absorbed in the positive electrode mixture to increase the water content in the positive electrode mixture. Although the change of the water content cannot be generally described because of the dependency on conditions such as the storage temperature of a battery, it may be completed within about one to three months after the assembly of a battery, and thereafter, the water content in the mixture will be maintained at a certain level. To keep the water content in the positive electrode mixture in this state at 8.4 to 10% by weight based on the total weight of the positive electrode mixture including the electrolytic solution, the composition and the amount of each electrolytic solution contained in the positive electrode and the negative electrode and charged afterwards are adjusted. If the water content is less than 8.4% by weight, problems occur in either the load characteristic, heating due to a short circuit or in the battery when stored at high temperatures. If the water content exceeds 10% by weight, which means that the amount of the electrolytic solution contained in the positive electrode mixture is excessive, the performance of the battery may be worsened due to the decrease of conductivity by swelling of the mixture and the shortage of an amount of electrolytic solution in the separator.

The water content and the concentration of potassium hydroxide in the electrolytic solution contained in the positive electrode mixture after the assembly of a battery are determined by disassembling the battery and analyzing the positive electrode mixture. For example, the water content can be determined from the weight change upon drying the positive electrode mixture in an atmosphere excluding the influence of carbon dioxide gas, such as in vacuo or in an inert gas atmosphere. The concentration of potassium hydroxide can be determined by measuring the amount of potassium in the mixture with the assumption that it may be all derived from potassium hydroxide, and calculating (amount of potassium hydroxide)/(amount of potassium hydroxide+water content). The concentration of potassium hydroxide is preferably from 35 to 39.5% by weight, but it should be clear that the composition of the electrolytic solution in the positive electrode mixture does not necessarily coincide with the composition of the electrolytic solution in the negative electrode mixture. Sometimes, when the alkaline concentration in the positive electrode mixture is higher than that in the negative electrode mixture, the transfer of water to the positive electrode terminates and such a state may be maintained.

In the present invention, as described above, because a sufficient amount of water is contained in the positive electrode mixture and the distribution of water in the battery is made appropriate, it becomes possible that the total amount of water in the battery system is made smaller than that required for conventional batteries, that is, it can be 0.23 to 0.275 g per gram of the positive electrode active material. Thus, due to the presence of no excessive water in the battery system, the battery characteristics deteriorate less during storage at high temperatures, and since there is sufficient water for the reaction, a battery having excellent operating characteristics can be obtained.

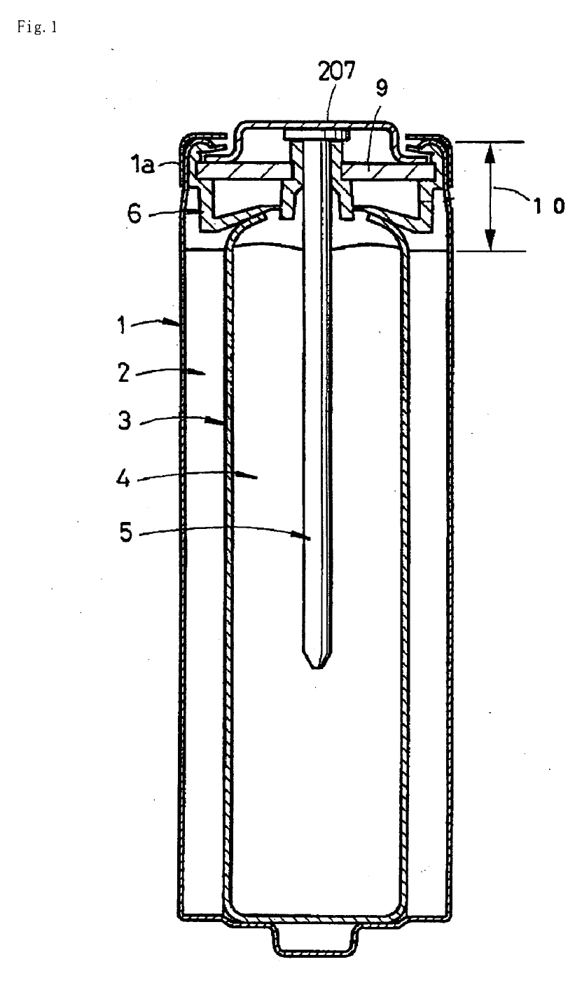

In the present invention, the shape of a battery is not limited particularly. In one preferred embodiment in which a cylindrical metal outer can is used, a battery is assembled by inserting the bobbin-form molded body of the positive electrode mixture in the interior of the outer can, placing a cup-shaped separator in the inner space of the bobbin-form molded body, injecting an alkaline electrolytic solution into the inside of the separator, filling the can with the negative electrode mixture, and sealing these components in the inside of the outer can. In the case of a cylindrical alkaline battery illustrated in FIG. 1, when the can opening is sealed by inwardly bending the open end 1a of an outer can 1, a metal washer 9 (a metal disk) is usually used as a support means for preventing the deformation of a negative electrode-terminal plate 207 and supporting a sealing member 6 from the inside. However, this structure has a problem in that the volume occupied by sealing part 10 is large.

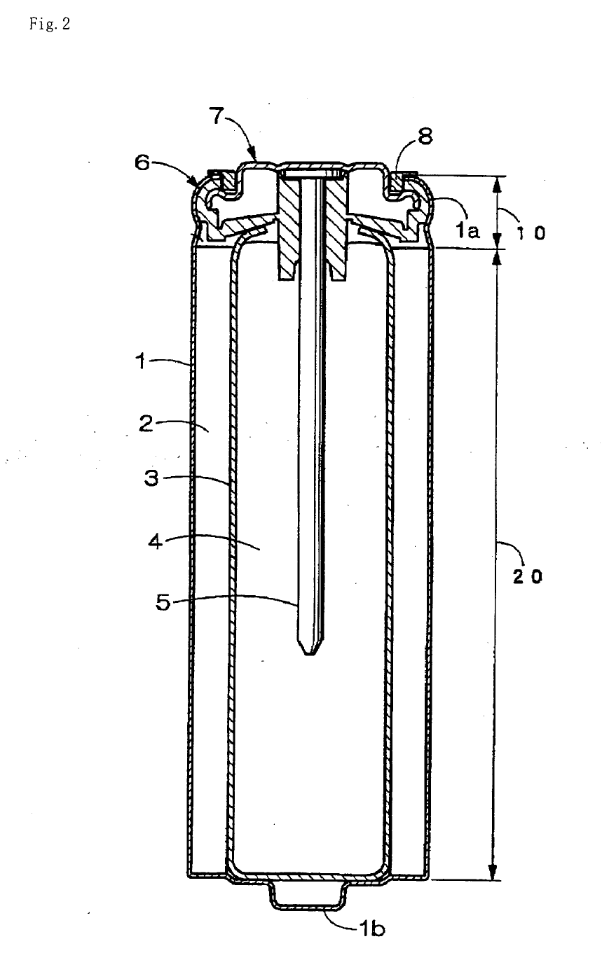

In contrast, another example of a battery, which is illustrated in FIG. 2, eliminates a metal washer and utilizes a negative electrode-terminal plate 7 as a support means for supporting a sealing member 6 from the inside, so that it has a reduced volume occupied by the sealing part 10. Thus, the filling amount of the mixtures for a positive electrode 2 and a negative electrode 4 can be increased. However, the amount of heat generated in the case of short circuiting may increase because the higher capacity of the battery. However, when the present invention applied to such a battery designed for achieving a high capacity, the usefulness of the battery can be enhanced, because the abnormal heating of the battery can be prevented.

Examples of the present invention are described below, but the present invention is not limited to these Examples.

### EXAMPLES

<General Procedures for Assembling a Battery>

Manganese dioxide containing 1.6% by weight of water, graphite, the details of which are described below, polytetrafluoroethylene powder and an alkaline electrolytic solution for positive electrode mixture preparation (a solution comprising 56% by weight of potassium hydroxide with 2.9% by weight of zinc oxide in water) were mixed in a weight ratio of 87.6:6.7:0.2:5.5 at 50° C. to prepare a positive electrode mixture having a density of 3.21 g/cm³. In this mixture, 7.6 parts by weight of graphite was used based on 100 parts by weight of manganese dioxide.

The concentration of potassium hydroxide in the electrolytic solution contained in the positive electrode mixture was 44.6% by weight with taking the water content of manganese dioxide into account, and the amounts of potassium hydroxide and water content were 3.1% by weight and 3.7% by weight, respectively based on the weight of the positive electrode mixture including the electrolytic solution.

Next, a zinc alloy powder containing indium, bismuth and aluminum in amounts of 0.05% by weight, 0.05% by weight and 0.005% by weight respectively, polysodium acrylate, polyacrylic acid and an alkaline electrolytic solution for negative electrode mixture (a solution comprising 32% by weight of potassium hydroxide with 2.2% by weight of zinc oxide in water) were mixed in a weight ratio of 39:0.2:0.2:18 to prepare a gel-type negative electrode mixture. The zinc alloy powder had an average particle, size of 122 μm, the particles of which passes through a sieve opening of 80 mesh but not through a sieve opening of 200 mesh, and a bulk density of 2.65 g/cm³.

As the outer body of a battery, an outer can 1 for a size AA alkaline dry battery made of a killed steel plate, the surface of which is plated with matt Ni plating, was used. This can had a thickness of 0.25 mm in a sealing part 10 and a thickness of 0.16 mm in a barrel part 20. Furthermore, a positive electrode-terminal part was slightly thicker than the barrel part 20 to prevent the formation of dents of a positive electrode-terminal lb when the battery falls. Using this outer can, an alkaline battery was produced as follows:

About 11 g of the positive electrode mixture was inserted into the outer can 1 and press-molded into a bobbin shape (hollow cylinder shape) to make three molded bodies of the positive electrode mixture, each having an inner diameter of 9.1 mm, an outer diameter of 13.7 mm and a height of 13.9 mm. Then, a groove was formed at 3.5 mm from an open end of the outer can 1 in vertical direction, and pitch was applied to the inside of the outer can 1 to the groove position in order to improve an adhesion of the outer can 1 and the sealing member 6.

Next, three plies of a nonwoven fabric consisting of acetalized polyvinyl alcohol fiber (Vinylon® of KURARAY Co., Ltd.) and cellulose fiber (Tencel® of LENZING) with a thickness of 100 μm and a weight of 30 g/m² were laminated and rolled into a cylinder, and its bottom part was folded and heat-sealed to make a cup-shaped separator 3 having the bottom end closed. This separator 3 was placed in the inside of the positive electrode 1 inserted into the outer can, and injected with 1.35 g of an alkaline electrolytic solution (a solution comprising 30% by weight of potassium hydroxide with 2.2% by weight of zinc oxide in water) inside the separator. Then, 5.74 g of the negative electrode mixture was charged in the inside of the separator 3 to make a negative electrode 4. At this time, the total amount of water in the battery system was 0.261 g per gram of the positive electrode active material.

After filling the above components for electric power generation, a negative electrode collector rod 5 was inserted in the center of the negative electrode. The negative electrode collector rod 5 consisted of a brass rod the surface of which was plated with tin, and was combined with a nylon 6-6 sealing member 6. Then, the collector rod 5 was clamped from the outside of the open end 1a of the outer can 1 by a spinning method to produce an AA alkaline battery as shown in FIG. 2. Here, the negative electrode collector rod 5 used was beforehand attached by welding on a negative electrode-terminal plate 7, which was made of nickel-plated steel having a thickness of 0.4 mm formed by punching and press working. In addition, an insulating plate 8 was attached for prevention of short circuit between the open end of the outer can 1 and the negative electrode-terminal plate 7. As described above, the alkaline batteries of Examples according to the present invention were produced.

<Measurements of Amounts of Potassium and Water Content>

After keeping the alkaline batteries produced in Examples at a temperature of 2° C.±2° C. and a relative humidity of 60%±15% RH for six months from the assembly of batteries, each battery was disassembled and the amounts of potassium and water contained in the positive electrode mixture were measured according to the following method.

The battery was disassembled, and divided into the positive electrode and the outer can, and the negative electrode and the separator. The weight of the positive electrode and the outer can was measured before and after drying them at 110° C. for twelve hours in vacuo, and the water content of the positive electrode mixture was calculated as a difference between weights before and after drying. Next, the positive electrode mixture after drying was taken out, and manganese dioxide was dissolved with an acid (hydrochloric acid). After removing the residue, the amount of potassium in the solution was determined by the atomic absorption spectrometry. From the amount of potassium measured by the above method, the amount of potassium hydroxide was calculated by a conversion according to the formula:
Amount of potassium hydroxide=Amount of potassium×(56.1/39.1)
where the atomic weight of potassium is 39.1 and the molecular weight of potassium hydroxide is 56.1.

Further, with the alkaline electrolytic solution contained in the positive electrode mixture after the assembly of the battery, the concentration of potassium hydroxide was determined according to the formula:
Concentration of potassium hydroxide=100×amount of KOH/(amount of KOH+water content)

As the result, the water content of the positive electrode mixture was 8.9% by weight, and the concentration of potassium hydroxide was 38.0% by weight.

<Measurement of BET Specific Surface Area>

A BET specific surface area is the total surface area of the surface of bulk active material particles and the micropores thereof, and is measured and calculated using the BET equation based on the theory of multi-layer molecular absorption. In measurement, a specific surface area measuring apparatus based on the nitrogen adsorption method (Macsorb HM Model 1201 manufactured by Mountech) was used.

<Measurement of Particle Size Distribution>

A particle size distribution was a particle size distribution determined based on the volumes of particles. The particle size was measured by sufficiently dispersing an active material in water using sonication, etc. to measure the particle size distribution. In the measurement, a particle size distribution measuring apparatus by laser scattering (Microtrac 9320HRA (X100), manufactured by Honeywell Inc.) was used. From the measured particle size distribution, a volume fraction of particles having particle size of 20 to 52 μm was determined.

<Measurement of Weight Loss by Heating>

A weight loss by heating is determined by measuring a decreased weight when a temperature is increased. In the measurement, a thermogravimetric measuring apparatus (TG8120 Thermo Plus, manufactured by Rigaku Corporation) was used to obtain a weight loss by heating a sample at a heating rate of 5° C./min. from 200° C. to 400° C.

<Analysis by Rietveld Method>

From the crystal structure analysis by the Rietveld method, manganese dioxide was identified as follows:

CuKα ray was used as a radiation source in the X-ray diffraction. Using trivalent manganese, tetravalent manganese and oxygen, a component percentage of a space group Pnma (62) was determined in the case of analyzing space groups as a mixed crystal of orthorhombic Pnma (62) and hexagonal P63/mmc (194). The component percentage determined by this analysis was hardly changed before and after the assembly of a battery. All S values at respective measuring points did not exceed 1.4.

### Example 1

In an alkaline battery prepared by the above-described method, manganese dioxide having the following properties was used as an active material:
BET specific surface area: 50 m²/g
Volume fraction of particles having a particle size of 20 to 52 μm: 53%
Ti content: 0.09%
Weight loss by heating: 3.0%
Component percentage of space group Pnma (62): 28%
Bulk density: 1.55 g/cm³

### Example 2

In an alkaline battery prepared by the above-described method, manganese dioxide having the following properties was used as an active material:
BET specific surface area: 50 m²/g
Volume fraction of particles having a particle size of 20 to 52 μm: 61%
Ti content: 0.09%
Weight loss by heating: 3.0%
Component percentage of space group Pnma (62): 28%
Bulk density: 1.55 g/cm³

### Example 3

In an alkaline battery prepared by the above-described method, manganese dioxide having the following properties was used as an active material:
BET specific surface area: 50 m²/g
Volume fraction of particles having a particle size of 20 to 52 μm: 67%
Ti content: 0.09%
Weight loss by heating: 3.0%
Component percentage of space group Pnma (62): 28%
Bulk density: 1.55 g/cm³

### Comparative Example 1

In an alkaline battery prepared in the same manner as that of Example 1, manganese dioxide having the following properties was used as an active material:
BET specific surface area: 35 m²/g
Volume fraction of particles having a particle size of 20 to 52 μm: 66%
Ti content: 0%
Weight loss by heating: 2.0%
Component percentage of space group Pnma (62): 37%
Bulk density: 1.60 g/cm³

### Comparative Example 2

In an alkaline battery prepared in the same manner as that of Example 1, manganese dioxide having the following properties was used as an active material:
BET specific surface area: 50 m²/g
Volume fraction of particles having a particle size of 20 to 52 μm: 44%
Ti content: 0.09%
Weight loss by heating: 3.0%
Component percentage of space group Pnma (62): 28%
Bulk density: 1.55 g/cm³

Examples 1 to 3 and Comparative Example 2 used manganese dioxide having a high specific surface area obtained by electrolyzing the solution of manganese sulfate and sulfuric acid containing a titanium compound as an electrolysis solution. Comparative Example 1 used manganese dioxide having a low specific surface area obtained by electrolyzing the solution of manganese sulfate and sulfuric acid as an electrolysis solution. The properties of the active materials used in Examples 1 to 3 and Comparative Examples 1 and 2 are summarized in Table 1.

TABLE 1

| | | Volume | | | Component | |
|---|---|---|---|---|---|---|
| | | fraction of | | | percentage | |
| Ex- | Specific | particles with | Ti | Weight | of space | |
| am- | surface | a particle size | con- | loss by | group | Bulk |
| ple | area | of 20 to 52 μm | tent | heating | Pnma (62) | density |
| No. | (m²/g) | (%) | (%) | (%) | (%) | (g/cm³) |
| | 50 | 53 | 0.09 | 3.0 | 28 | 1.55 |
| 2 | 50 | 61 | 0.09 | 3.0 | 28 | 1.55 |
| 3 | 50 | 67 | 0.09 | 3.0 | 28 | 1.55 |
| C. 1 | 35 | 66 | 0.00 | 2.0 | 37 | 1.60 |
| C. 2 | 50 | 44 | 0.09 | 3.0 | 28 | 1.55 |

### Example 4

In an alkaline battery prepared in the same manner as that of Example 1, manganese dioxide, which was the mixture of 50% by weight of the manganese dioxide used in Example 1 and 50% by weight of the manganese dioxide used in Comparative Example 1, was used as an active material. After mixing, the volume fraction of particles having a particle size of 20 to 52 μm in the manganese dioxide was 60%.

### Example 5

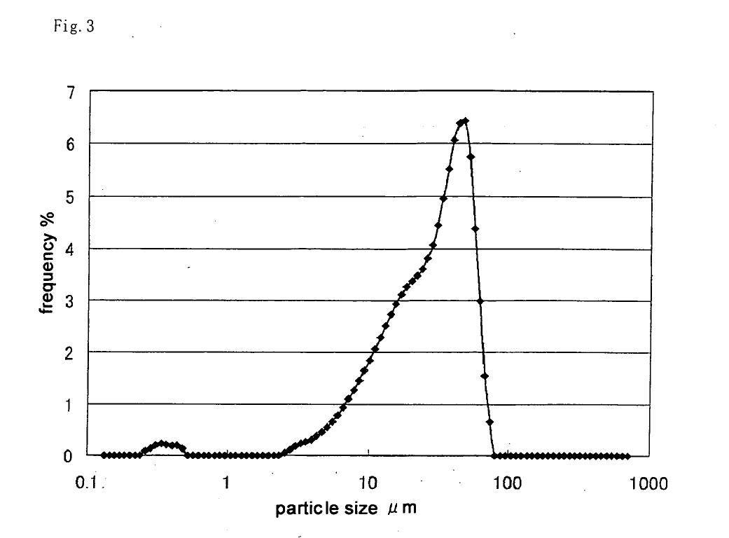

In an alkaline battery prepared in the same manner as that of Example 1, manganese dioxide, which was the mixture 50% by weight of the manganese dioxide used in Comparative Example 1 and 50% by weight of the manganese dioxide used in Comparative Example 2, was used as an active material. After being mixed, the volume fraction of particles having a particle size of 20 to 52 μm in the manganese dioxide was 55%. The particle size distribution of the manganese dioxide after mixing was shown in FIG. 3.

### Example 6

In an alkaline battery prepared in the same manner as that of Example 1, manganese dioxide, which was a mixture of 30% by weight of the manganese dioxide used in Example 1 and 70% by weight of the manganese dioxide used in Comparative Example 1, was used as an active material. After mixing, the volume fraction of particles having a particle size of 20 to 52 μm in the manganese dioxide was 62%.

### Example 7

In an alkaline battery prepared in the same manner as that of Example 1, manganese dioxide, which was a mixture of 80% by weight of the manganese dioxide used in Example 1 and 20% by weight of the manganese dioxide used in Comparative Example 1, was used as an active material. After mixing, the volume fraction of particles having a particle size of 20 to 52 μm in the manganese dioxide was 56%.

The mixing ratios and the volume fractions of particles having a particle size of 20 to 52 μm of manganese dioxide used in Examples 4 to 7 are summarized in Table 2.

TABLE 2

| | Mixing ratio (% by weight) | | | Volume fraction of |
|---|---|---|---|---|
| | | MnO₂ in | MnO₂ in | particles having |
| | MnO₂ in | Comparative | Comparative | a particle size of |
| | Example 1 | Example 1 | Example 2 | 20 to 52 μm (%) |
| Example 4 | 50 | 50 | — | 60 |
| Example 5 | — | 50 | 50 | 55 |
| Example 6 | 30 | 70 | — | 62 |
| Example 7 | 80 | 20 | — | 56 |

Next, with each battery of Examples 1 to 7 and Comparative Examples 1 and 2, a load characteristic was measured and a moldability of a positive electrode mixture was checked as follows:

The load characteristic was evaluated by the number of pulse discharges at which a voltage at a pulsed current of 2 A flowing decreased to 1.0V or less in a pulse discharge test with applying a pulsed current of 2 A for two seconds with thirty seconds interval at 0.5 A of the base discharge current.

The moldability of a positive electrode mixture was measured using a push-pull gauge in terms of a strength at which a bobbin-form (hollow cylinder shaped) molded body prepared according to the above-described method was crushed in a cylinder part with a lateral load. The measurement was repeated with three samples of the molded body (N=3), and evaluated with their averaged value. Because the productivity is extremely decreased, if the strength of molded body measured as above is 500 g or less, the strength must be at least 500 g in view of the productivity.

The number of the pulse discharges and the strength of the molded bodies are summarized in Table 3.

TABLE 3

| | Number of | Strength of |
|---|---|---|
| | pulse discharge | molded body (g) |
| Ex. 1 | 101 | 560 |
| Ex. 2 | 102 | 620 |
| Ex. 3 | 104 | 720 |
| Comp. Ex. 1 | 80 | 800 |
| Comp. Ex. 2 | 100 | 360 |
| Ex. 4 | 92 | 630 |
| Ex. 5 | 91 | 580 |
| Ex. 6 | 86 | 700 |
| Ex. 7 | 96 | 600 |

The battery of Example 1 according to the present invention maintained the sufficient strength of molded body for withstanding the production conditions, could be produced stably, and had the increased number of pulse discharges and the improved load characteristic because of the use of manganese dioxide having a high specific surface area in an optimal particle size distribution. In Examples 2 and 3, the strength of molded bodies were further increased.

In contrast, in Comparative Example 1, the number of pulse discharges decreased because of the use of manganese dioxide having a smaller specific surface area than in Example 1 and was outside the range of the present invention. In Comparative Example 2, because of the use of manganese dioxide having a large specific surface area, the battery had the increased number of pulse discharge and a more improved load characteristic than Comparative Example 1, but the battery did not maintain the sufficient strength of molded body and had difficulty in handling during the production because the particle size distribution was outside of the range of the present invention,

The battery of Example 4 had a slightly decreased number of pulse discharges in comparison with Example 1, but could have the improved strength of molded body since the mixture of manganese dioxide having a high specific surface area in Example 1 and manganese dioxide in Comparative Example 1 was used. In Example 5, since the mixture of manganese dioxide having a high specific surface area in Example 1 and manganese dioxide having a high specific surface area in Comparative Example 2 was used, the manganese dioxide had the specific surface area and the particle size distribution within the range of the present invention, and the battery was within the range according to the second aspect of the present invention. It had an increased number of pulse discharges when compared to Comparative Example 1. Also, it had an improved strength of the molded body when compared to Comparative Example 2, and as such, could withstand the production conditions and the improved load characteristic.

The battery of Example 6 had a decreased number of pulse discharges when compared to Example 5, but had a more improved strength of molded body, because of the reduced mixing percentage of manganese dioxide having a large specific surface area. In Example 7, the battery had an increased number of pulse discharges when compared with Example 6 and the further improved strength of molded body in comparison with Example 1 because of the increased amount of manganese dioxide having a large specific surface area.

1. An alkaline battery comprising manganese dioxide as a positive electrode active material, wherein the positive electrode active material has a BET specific surface area of 40 to 100 m²/g and a particle size distribution wherein a volume fraction of particles having a particle size of 20 to 52 μm is at least 50%.

2. The alkaline battery according to claim 1, wherein the positive electrode active material has a BET specific surface area of 40 to 60 m²/g.

3. The alkaline battery according to claim 1, wherein the positive electrode active material has a particle size distribution wherein a volume fraction of particles having a particle size of 20 to 52 μm is at least 60%.

4. An alkaline battery comprising manganese dioxide as a positive electrode active material, wherein the manganese dioxide is a mixture of high specific surface area manganese dioxide having a BET specific surface area of 40 to 100 m²/g and low specific surface area manganese dioxide having a BET specific surface area of less than 40 m²/g.

5. The alkaline battery according to claim 4, wherein a mixing ratio of said high specific surface area manganese dioxide to said low specific surface area manganese dioxide is from 30:70 to 95:5 by weight.

6. The alkaline battery according to claim 4, wherein the manganese dioxide is a mixture of high specific surface area manganese dioxide having a BET specific surface area of 45 to 70 m²/g and low specific surface area manganese dioxide having a BET specific surface area of less than 40 m²/g.

7. The alkaline battery according to claim 1, wherein said manganese dioxide comprises 0.01 to 3% by weight of titanium.

8. The alkaline battery according to claim 4, wherein said high specific surface area manganese dioxide comprises 0.01 to 3% by weight of titanium.

9. The alkaline battery according to claim 1, wherein said manganese dioxide has a weight loss upon heating at a rate of 5° C./min from 200° C. to 400° C. of at least 2.5%.

10. The alkaline battery according to claim 4, wherein said high specific surface area manganese dioxide has a weight loss upon heating at a rate of 5° C./min from 200° C. to 400° C. of at least 2.5%.

11. The alkaline battery according to claim 1, wherein said manganese dioxide has a component percentage of 32% or less of a space group Pnma (62), when analyzed by the Rietveld method as a mixed crystal of space groups orthorhombic Pnma (62) and hexagonal P63/mmc (194), in a X-ray diffraction measurement.

12. The alkaline battery according to claim 4, wherein said high specific surface area manganese dioxide has a component percentage of 32% or less of a space group Pnma (62), when analyzed by the Rietveld method as a mixed crystal of space groups orthorhombic Pnma (62) and hexagonal P63/mmc (194), in a X-ray diffraction measurement.

13. The alkaline battery according to claim 1, wherein the positive electrode active material after the assembly of the battery contains an alkaline electrolytic solution comprising potassium hydroxide, and a water content in said positive electrode mixture is 8.4 to 10% by weight based on the weight of the positive electrode mixture including the electrolytic solution.

14. The alkaline battery according to claim 4, wherein the positive electrode active material after the assembly of the battery contains an alkaline electrolytic solution comprising potassium hydroxide, and a water content in said positive electrode mixture is 8.4 to 10% by weight based on the weight of the positive electrode mixture including the electrolytic solution.

15. The alkaline battery according to claim 1, wherein a density of the positive electrode mixture before the assembly of the battery is from 3.2 to 3.35 g/cm³.

16. The alkaline battery according to claim 4, wherein a density of the positive electrode mixture before the assembly of the battery is from 3.2 to 3.35 g/cm³.

17. The alkaline battery according to claim 1, wherein a zinc alloy powder is used as a negative electrode active material, and a percentage of zinc alloy powder passing through sieve openings of 200 mesh is 4 to 50% by weight.

18. The alkaline battery according to claim 4, wherein a zinc alloy powder is used as a negative electrode active material, and a percentage of zinc alloy powder passing through sieve openings of 200 mesh is 4 to 50% by weight.

19. The alkaline battery according to claim 1, wherein said positive electrode active material comprises at least 3 parts of a conductive agent per 100 parts of positive electrode active material.

20. The alkaline battery according to claim 4, wherein said positive electrode active material comprises at least 3 parts of a conductive agent per 100 parts of positive electrode active material.
